(19) United States
(12) Patent Application Publication
(10) Pub. No.: US 2020/0385288 A1
(43) Pub. Date: Dec. 10, 2020

(54) CYSTEINE RICH PROTEINS FOR HEAVY METAL DECONTAMINATION OF WASTE WATER FROM OIL AND GAS INDUSTRIES

(71) Applicant: Baker Hughes, a GE company, LLC, Houston, TX (US)

(72) Inventors: Prasad Dhulipala, Katy, TX (US); Soma Chakraborty, Houston, TX (US); Jerry J. Weers, Richmond, TX (US); Marilyn Blaschke, Richmond, TX (US)

(73) Assignee: Baker Hughes, a GE company, LLC, Houston, TX (US)

(21) Appl. No.: 16/434,833

(22) Filed: Jun. 7, 2019

(51) Int. Cl. C02F 1/28; B01J 20/24

(52) U.S. Cl. CPC C02F 1/286; C02F 2101/20; B01J 20/24

(57) ABSTRACT

Waste water streams from an oil or gas recovery or refinery operation contaminated with a metal such as a heavy metal (e.g. mercury) can be treated with a protein including chordin and chordin-like proteins so that ion bonding the protein with the metal occurs to give a metal protein complex. The metal protein complex is then removed from the aqueous stream by a process such as flocculation and/or filtration.

### TECHNICAL FIELD

The present invention relates to methods and compositions for removing metal contaminants from aqueous streams, and more specifically relates to methods and compositions for removing heavy metal contaminants from oil and gas industry waste waters.

### BACKGROUND

Pollution from heavy metals has become a serious threat to public health. It has been well established that the nonessential heavy metals such as mercury, cadmium, and lead can be highly toxic even at low concentration through generation of reactive radicals. Heavy metals may be among the main contaminants found in industrial wastewater streams, such as wastewater streams from an oil and gas refinery, or oil and gas recovery operations. Many different processes and additives have been used to clean, purify, clarify and otherwise treat wastewater streams to remove such contaminants to meet environmental standards for discharge of the treated wastewater stream, reuse of the treated wastewater stream, and other purposes.

For example, natural material-based polymers, such as starch and chitosan, are well-known for their ability to clean up particulates and oily contaminants with their high-charge density from water. In addition, functionalized polymers with sulfur- and/or nitrogen-containing moiety chelating groups have been used for heavy metal removal from aqueous streams.

However, waste water streams from oil and/or gas recovery and/or refinery operations present particular challenges because of their complex composition. It would be desirable if further methods and additives were developed for treating aqueous waste waters produced during hydrocarbon recovery and oil and gas refining to remove heavy metals from these streams.

### SUMMARY

There is provided, in one non-restrictive form, a method for reducing a concentration of at least one metal in an aqueous stream contaminated therewith with at least one protein, where the protein includes chordin and/or chordin-like proteins. A chordin-like protein is a protein that contains a chordin domain of 60-80 amino acids in length and is characterized by at least ten cysteine residues. The at least one protein is present in an amount effective to ion bond with the metal. The method further includes ion bonding the protein with the at least one metal to give a metal protein complex; and removing metal protein complex from the aqueous stream.

There is provided, in a non-limiting embodiment, a treated aqueous composition that includes an aqueous stream, which may optionally be a waste water stream from an oil or gas recovery or refinery operation, comprising at least one heavy metal contaminant and at least one protein that includes chordin and/or chordin-like proteins, where a chordin-like protein is a protein that contains a chordin domain of 60-80 amino acids in length and characterized by at least ten cysteine residues, and where the protein is present in an amount effective to ion bond with the at least one heavy metal contaminant.

### BRIEF DESCRIPTION OF THE DRAWINGS

In order to more fully understand the drawings referred to in the detailed description, a brief description of each drawing is presented here:

FIG. 1 is a schematic representation of chordin-like CR domains in various proteins; and

FIG. 2 is a schematic representation of non-limiting areas of application for mercury mitigation in one type of oil refinery.

### DETAILED DESCRIPTION

It has been discovered that peptides with an abundance of cysteine (Cys) residues are known to bind heavy metals with high affinity. Sulfur-rich metal-sequestering peptides, such as glutathione (GSH), metallothioneins (MTs) and phytochelatins (PCs) are very important to biological defense strategies against heavy metal poisoning. Chordin and chordin-like are cysteine rich (CR) proteins and the CR domains are typically 60-80 amino acids in length and characterized by at least ten cysteine residues with a conserved spacing pattern. As defined herein, a “conserved spacing pattern” means that each domain has a defined amino acid sequence that forms a spacing pattern. Metals mainly bind to free SH groups in cysteine and spacing will not participate in this binding.

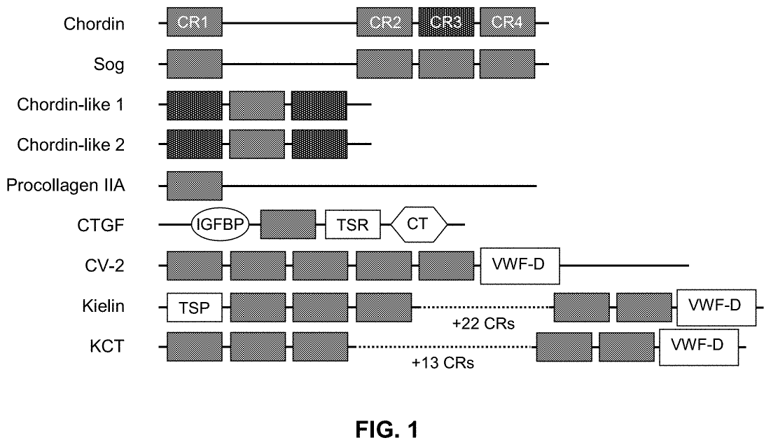

Shown in FIG. 1 is a schematic representation of chordin-like CR domains in various proteins including Sog, chordin-like protein 1, chordin-like protein 2, Procollagen IIA, connective tissue growth factor (CTGF), Crossveinless-2 (CV-2), Kielin, Kielin/chordin-like protein (KCP). The gray boxes in FIG. 1 correspond to CR domains. Information in FIG. 1 is from J. Garcia Abreu, et al., “Chordin-like CR domains and the Regulation of Evolutionarily Conserved Extracellular Signaling Systems”, Gene, Vol. 287, pp. 39-47, 2002, incorporated herein by reference in its entirety. Xenopus Kielin contains a total of 27 CR domains, while its mammalian homolog KCP contains 18 CR domains. Combinations of chordin and chordin-like proteins may also be used in a variety of ratios. It may be discovered that certain chordin and chordin-like proteins in different combinations and/or ratios may work better in applications at certain sites than other combinations or ratios.

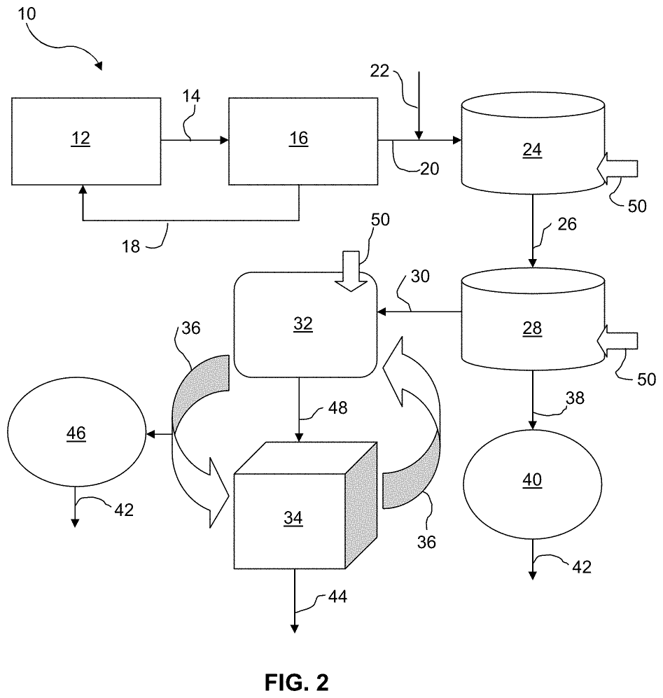

It has been discovered that certain cysteine rich proteins with several cysteine repeats are useful for heavy metal decontamination (mainly mercury) of oil and gas waste water as shown in FIG. 2, which is a schematic representation of non-limiting areas of application for mercury mitigation in one type of oil refinery operations 10. The equipment and unit operations are or may be conventional. Briefly, desalter 12 performs an initial separation of crude oil and water and discharges oily brine 14 to API separator 16. Any oil 18 separated from the oily brine 14 by the API separator 16 is recycled back to the desalter 12 as a slop oil or is sent to another process unit, usually a coker. Water 20 separated out by the API separator 16 is combined with water 22 from other refinery sources and fed to equilibrium tank 24. Effluent 26 from equilibrium tank 22 is sent to dissolved air flotation tank 28. Water float 38 from dissolved air flotation tank 28 goes to filter press 40 which discharges solid waste 42. Aqueous stream 30 from dissolved air flotation tank 28 is directed to bioreactor 32. While discharge 48 from bioreactor 32 goes to clarifier 34, bacteria recycling between bioreactor 32 and clarifier 34 is indicated by arrows 36. Clarified water 44 from which metals have been removed can be discharged to the environment. The balance of the flow goes to filter press 46 and the solid waste 42 contains the metals. The chordin and/or chordin-like proteins, also known as metal scavenger, may be introduced at one or more of a variety of application points, including, but not necessarily limited to, equilibrium tank 22, dissolved air flotation tank 28, and/or bioreactor 32, as indicated by arrows 50.

The heavy metals will mainly bind to the —SH groups of the cysteine amino acids. Since the chordin proteins contain 60-80 amino acids in length and are characterized by at least ten cysteine residues, there are a large number of sites where the protein can ion bond with the metal. This ion bonding of the protein with the metal gives a metal protein complex. Other proteins not part of this method are relatively smaller in nature and do not have this signature sequence. The proteins and peptides are added in aqueous form. In one non-limiting embodiment, the molar ratio of —SH group metal scavenger to metal ranges from about 1:1 independently to about 10:1; alternatively from about 2:1 independently to about 8:1. As used herein with respect to a range, the term “independently” means that any threshold may be used together with any other threshold to give a suitable alternative range.

In one non-limiting embodiment of the method, there is an absence of delivering the protein metal scavenger along with live bacteria that produces it. Stated another way, the concentration of live bacteria that produces the at least one protein is below detection levels. It is important not to use live bacteria because the microbial population may grow unhindered, which growth would need treatment with biocides. Disadvantages of using live bacteria also include having to immobilize them and making them reusable. In another non-restrictive version, the protein metal scavengers can be recombinant proteins, synthetic proteins, and combinations thereof.

In another non-limiting embodiment, the method is not limited to any particular treatment conditions, but may be practiced at a temperature range between about 20 independently to about 50° C. (about 68 to about 122° F.), alternatively between about 5 independently to about 80° C. (about 41 to about 176° F.).

After protein(s) ion bond with the metal, the resultant metal protein complex may be removed from the aqueous stream by any suitable process including, but not necessarily limited to, flocculation, filtration, and combinations thereof.

The metals removed from the aqueous stream can include any one or more of the metals generally understood in the art as heavy metals. In one non-limiting embodiment the heavy metals include, but are not necessarily limited to, mercury, cadmium, lead, zinc, copper, cobalt, nickel, platinum, silver, gold, chromium, arsenic, thallium, and combinations thereof. In a particular non-restrictive version, the heavy metal is mercury.

The method for removing metals from aqueous streams using the protein scavengers may be generally used on any aqueous stream containing the metals or heavy metals. The method is particularly suitable for treating waste water streams from oil and/or gas recovery operations, that is, waste water streams produced during recovering oil and/or gas from subterranean formations, as well as waste water streams from oil and/or gas refinery operations.

In the foregoing specification, the invention has been described with reference to specific embodiments thereof, and has been described as effective in providing methods, scavenger compositions, and treated fluid compositions for decreasing and/or removing metals, particularly heavy metals, in aqueous streams containing the metals. However, it will be evident that various modifications and changes can be made thereto without departing from the broader scope of the invention as set forth in the appended claims. Accordingly, the specification is to be regarded in an illustrative rather than a restrictive sense. For example, specific aqueous fluids, metals, proteins, treatment protocols, treatment temperatures, additional components, scavenger proportions, amount of CR domains in the proteins, and the like falling within the claimed parameters, but not specifically identified or tried in a particular composition or method, are expected to be within the scope of this invention.

The present invention may suitably comprise, consist or consist essentially of the elements disclosed and may be practiced in the absence of an element not disclosed. For instance, there may be provided a method for reducing a concentration of at least one metal in an aqueous stream, where the method consists essentially of or consists of contacting an aqueous stream contaminated with a metal with at least one protein selected from the group consisting of chordin, chordin-like proteins, and combinations thereof, where a chordin-like protein is a protein that contains a chordin domain of 60-80 amino acids in length and characterized by at least ten cysteine residues, where the protein is present in an amount effective to ion bond with the at least one metal; ion bonding the protein with the at least one metal to give a metal protein complex; and removing metal protein complex from the aqueous stream.

Alternatively, there may be provided a treated aqueous composition that consists of or consists essentially of an aqueous stream (optionally a waste water stream from an oil or gas recovery or refinery operation) comprising at least one heavy metal contaminant; and at least one protein selected from the group consisting of chordin, chordin-like proteins, and combinations thereof, where a chordin-like protein is a protein that contains a chordin domain of 60-80 amino acids in length and characterized by at least ten cysteine residues, and where the protein is present in an amount effective to ion bond with the at least one heavy metal contaminant.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for reducing concentration of at least one metal in an aqueous steam, the method comprising:
contacting an aqueous stream contaminated with the at least one metal with at least one protein selected from the group consisting of chordin, chordin-like proteins, and combinations thereof, where:
the chordin-like protein is a protein that contains a chordin domain of 60-80 amino acids in length and is characterized by at least ten cysteine residues; and
the at least one protein is present in an amount effective to ion bond with the at least one metal;
ion bonding the protein with the at least one metal producing a metal protein complex; and
removing the metal protein complex from the aqueous stream.

2. The method of claim 1, where the effective amount of the at least one protein to the at least one metal ranges from about a 1:1 mole ratio to about a 10:1 mole ratio.

3. The method of claim 1 where the chordin-like proteins are selected from the group consisting of Sog, chordin-like protein 1, chordin-like protein 2, Procollagen IIA, CTGF, Crossveinless-2, Kielin, Kielin/chordin-like protein, and combinations thereof.

4. The method of claim 1 where contacting the aqueous stream with the at least one protein comprises introducing the at least one protein into the aqueous stream without live bacteria that produce it.

5. The method of claim 5 where the at least one protein is selected from the group consisting of recombinant proteins, synthetic proteins, and combinations thereof.

6. The method of claim 1 where contacting the aqueous stream contaminated with the at least one metal with the at least one protein and ion bonding the protein with the metal to give a metal protein complex occur at a temperature in the range of from about 20 to about 50° C.

7. The method of claim 1 where the at least one metal is a heavy metal.

8. The method of claim 7 where the heavy metal is mercury.

9. The method of claim 1 where removing metal protein complex from the aqueous stream is accomplished by a process selected from the group consisting of flocculation, filtration, and combinations thereof.

10. The method of claim 1 where the aqueous stream is a waste water stream from an oil or gas recovery or refinery operation.

11. A method for reducing concentration of at least one heavy metal in an aqueous steam, the method comprising:
contacting an aqueous stream contaminated with the at least one heavy metal with at least one protein selected from the group consisting of chordin, chordin-like proteins, and combinations thereof, where:
the chordin-like protein is a protein that contains a chordin domain of 60-80 amino acids in length and is characterized by at least ten cysteine residues; and
the protein is present in a mole ratio of at least one protein to at least one heavy metal of about a 1:1 mole ratio to about a 10:1 mole effective to ion bond with the at least one heavy metal;
ion bonding the at least one protein with the at least one heavy metal producing a metal protein complex; and
removing the metal protein complex from the aqueous stream.

12. The method of claim 11 where contacting the aqueous stream contaminated with a metal with the at least one protein and ion bonding the protein with the metal to give a metal protein complex occur at a temperature in the range of from about 20 to about 50° C.

13. The method of claim 11 where the heavy metal is mercury.

14. The method of claim 11 where removing metal protein complex from the aqueous stream is accomplished by a process selected from the group consisting of flocculation, filtration, and combinations thereof.

15. A treated aqueous composition comprising:
an aqueous stream comprising at least one heavy metal contaminant; and
at least one protein selected from the group consisting of chordin, chordin-like proteins, and combinations thereof, where
the chordin-like protein is a protein that contains a chordin domain of 60-80 amino acids in length and characterized by at least ten cysteine residues, and
the protein is present in an amount effective to ion bond with the at least one heavy metal contaminant.

16. The treated aqueous composition of claim 15 where the aqueous stream is a waste water stream from an oil or gas recovery or refinery operation

17. The treated aqueous composition of claim 15 where the effective amount of the at least one protein to at least one heavy metal contaminant ranges from about a 1:1 mole ratio to about a 10:1 mole ratio.

18. The treated aqueous composition of claim 15 where the chordin-like proteins are selected from the group consisting of Sog, chordin-like protein 1, chordin-like protein 2, Procollagen IIA, CTGF, Crossveinless-2, Kielin, Kielin/chordin-like protein, and combinations thereof.

19. The treated aqueous composition of claim 15 where concentration of live bacteria that produces the at least one protein is below detection levels.

20. The treated aqueous composition of claim 15 where the at least one heavy metal contaminant is mercury.
